(19) United States
(12) Patent Application Publication
(10) Pub. No.: US 2002/0032650 A1
(43) Pub. Date: Mar. 14, 2002

(54) Payment system and method

(76) Inventors: Elloyd A. Hauser, Sarasota, FL (US); Joseph F. Keller, Plymouth, MN (US)

Correspondence Address: Beck & Tysver, P.L.L.C., Suite 100, 2900 Thomas Avenue South, Minneapolis, MN, 55416-4477, US

(21) Appl. No.: 09/861,911

(22) Filed: May 21, 2001

Related U.S. Application Data
(60) Provisional application No. 60/205,991, filed on May 19, 2000.

(51) Int. Cl. G06F 17/60

(52) U.S. Cl. 705/40

(57) ABSTRACT

A system and method of making a payment to a payee upon presentation by the payee of a predefined code is described. A code is assigned for a specified payment transaction and is stored in association with the predefined payment amount. A payee requests payment and provides the previously-assigned code. The payor uses the code to look up the amount to be paid and makes payment to the payee. The system and method can incorporate security measures to reduce fraud. The system and method offer particular advantage in the context of the issuance of rebates and refunds.

This application claims priority under 35 USC §119(e) to U.S. patent application Ser. No. 60/205,991, filed May 19, 2000.

### FIELD OF THE INVENTION

The present invention relates generally to a payment system and method and more particularly to a system and method for digitally distributing rebates, refunds, payroll dollars, and many other kinds of payments.

### BACKGROUND OF THE INVENTION

In the payments industry, printing and issuing checks to businesses, employees, and consumers is a routine process. Despite it being a common practice, companies consistently experience problems in the managing of these payments. Companies experience costs of errors, delays, customer dissatisfaction and many low-level managing issues resulting from, or arising in conjunction with, the coordination of the printing of the checks, mailing checks, banking and transaction clearing and reconciling, and the escheatment reporting of the non-redeemed payments. This is a particular problem where a company must dispense payments to a large number of recipients, and where each recipient receives one or a small number of payments.

The issuance of rebate offers has been one common marketing practice that has typically involved the issuance of a paper check. Rebates are offered, by retailers or manufacturers, to encourage sales of particular items. A rebate is a refund of a specified portion of the purchase price, making the ultimate purchase price lower than the initial purchase price. The traditional rebate issuance and redemption process 10 is illustrated in FIG. 1. A consumer purchases a product (11) in a store or by mail order or otherwise. The product comes with a rebate offer, typically with a small rebate coupon or form. The consumer fills in the requested information on the paper form, typically their name and an address at which they wish to receive the rebate check. The consumer mails the paper rebate coupon, along with any other requested information or items such as the sales receipt for the product and proof of purchase, typically the UPC code, from the product packaging, to a “fulfillment house” (12). A fulfillment house is an institution that receives and ships orders, with whom manufacturers or other merchants often contract to fulfill consumer orders for goods or rebates. The U.S. postal service or other mail delivery carrier delivers the consumer's rebate coupon to a fulfillment house (13). When the fulfillment house receives the rebate coupon (14), a person enters into a database (15) the pertinent information, such as the consumer's name and address and the amount of the rebate and other required information as defined by the rebate. The fulfillment house then prints a rebate check (16) and mails it to the consumer (17). The consumer receives the rebate check in the mail and deposits it into a bank account (18). A bank or other payment processor, on whose account the rebate check was written, pays the rebate (19) when the consumer cashes the check. The bank/payment processor reports (20) the payment to their client, commonly the manufacturer, who ultimately pays the bank/payment processor for their services and for the rebate amount. The bank/payment processor functions as both a treasurer and as a marketing information source for the manufacturer, providing reports regarding consumers who redeemed their rebates, the rate of redemption of the rebates, outstanding payments, escheatment information, and the like.

This current system is cumbersome and slow, typically taking four to eight weeks for complete processing. The system requires at least two mailings, which each typically take two or more days. Further, because the fulfillment house must type the customer's address information, there is a likelihood of error that the check will be sent to the wrong address or otherwise confuse the records of the fulfillment house and prevent the customer from receiving their rebate. When a customer does not receive their rebate, either due to error or just due to processing time, the customer will have to take the time to make follow-up phone calls or send follow-up letters, and the fulfillment house must take the time to investigate and respond. This process is therefore often dissatisfying to the consumer.

Further, this system offers opportunities for fraud and abuse. To fraudulently collect rebate refunds, a purported customer can purchase a product and remove the UPC code, submit a copy of the receipt with the UPC code for a rebate, and then return the product itself. In another fraud scheme, a defrauder will obtain a rebate check, perhaps in a legitimate manner, and then counterfeit the check, using the routing number and account number from their paper rebate check.

Besides rebates, there exist innumerable other transactions that involve the issuance of a check, and more particularly involve the issuance of checks for small amounts, for one-time payments or for irregular or short-term payments that do not lend themselves efficiently to standard procedures for issuing and disseminating paper checks. For example, refunds, such as a refund on a cancelled subscription, token payment to someone for participating in a survey, and payment(s )to an independent contractor for a job. In cases such as these, the issuance of a paper check has transaction costs (in time and/or money) that are undesirable particularly in proportion to the amount of the check.

### SUMMARY OF THE INVENTION

What is needed is an alternative solution that addresses the problems of printed checks, but one that is secure and efficient. According to one aspect of the invention, a solution is presented that is automated and incorporates the use of the internet or networked computers to facilitate automatic and speedy processes.

According to another aspect of this invention, a third party payment processor obtains a list of assigned codes from a payor, where each code is associated with a product or a transaction. The payor provides one such pre-assigned code to a payee. The payee makes his/her/its request for payment from the third party payment processor, and the request includes the code. The payment processor performs a veracity or validity check against the list of assigned codes. In addition, the payment processor performs another check against a database having records from one or more other manufacturers to identify potentially problematic rates of requests for rebate redemptions which would suggest attempts to fraudulently obtain payments.

According to one aspect of the invention, a payor assigns a unique transaction code to a payment to be made to a payee. The payor communicates or provides the transaction code to a payee and to a payment processor. The payee, to receive the payment, communicates the code to the payment processor and the payment processor issues the payment.

According to another aspect of the invention, rebates are processed. A consumer purchases a product to which is attached or provided in the product's packaging, a rebate identifier and directions for accessing the web site of a rebate provider. The consumer accesses the web site of the rebate provider and enters the data requested, including the rebate identifier and information identifying the consumer. The rebate provider then forwards the rebate to the consumer.

According to another aspect of the invention, the rebate is distributed digitally to the consumer. More specifically, the consumer provides to the rebate provider the consumer's bank account information, including its routing number. Instead of sending the consumer a check, the rebate provider orders a transfer of funds for the rebate amount directly into the consumer's bank account.

According to still another aspect of the invention, a rebate provider establishes a system for tracking and distributing rebates electronically or digitally through networked computers. The rebate provider establishes a database that stores records for each rebate to be dispensed. The rebate provider's clients, such as a manufacturer or retailer that will ultimately pay the rebate, assign to each rebate offer a unique identifier. The client then provides to the rebate provider a list or file of unique identifiers along with associated data, such as the amount of the rebate. Each rebate record includes a rebate identifier, the rebate amount and various other data. The rebate provider communicates with consumers via a web site. The web site offers forms for users to fill out to provide the information requisite to redeeming a rebate. When a consumer requests a rebate via the web site, the request will include a rebate identifier and information necessary for the rebate provider to send or digitally transmit the rebate to the consumer or to the consumer's account. The rebate provider accesses the associated rebate record in its database and identifies the amount of the rebate. The rebate provider then dispenses the rebate to the consumer. If the consumer provides their bank account information (i.e. the routing number and account number), the rebate provider dispenses the rebate directly into the consumer's account. The rebate provider also automatically debits the account of its client, the manufacturer or retailer or other entity that offered the rebate.

According to another aspect of this invention, the customer accesses the retailer or manufacturer's web site, on which is located the forms for the consumer to fill out to have their rebate redeemed.

According to another aspect of this invention, security measures are incorporated into a system and method for digitally distributing rebates. At the time of purchase, the retailer provides the consumer with a receipt. This receipt bears a unique identifier in association with the sale of a product subject to a rebate offer. The retailer provides to the manufacturer a list of these receipt identifiers. The manufacturer then provides these receipt numbers in association with a product identifier to the rebate provider or payment processor. Alternatively, the retailer provides the list of unique identifiers directly to the payment provider, and the payment provider links them to the product identifiers provided to it by the manufacturer. The rebate provider stores the receipt number in association with rebate identifiers. In this secure system and method, the consumer will be required to transmit both the rebate identifier and their receipt identifier via the rebate provider's web site. The rebate provider will then perform a security check of its own database to confirm that the submitted receipt identifier and rebate identifier are appropriately paired. If so, the rebate is distributed.

According to another aspect of this invention, refunds or other types of one-time or recurring payments are processed and made in an automated way via automated, electronic methods. An example of such a situation where the present system and method would offer advantage includes a single payment to an independent contract by an employer for services performed. After performing services, the employer provides the contractor with a code and web address. The contractor accesses the web address, provides the code and, optionally, their bank account number and routing number. The payment provider transmits payment directly to the contractor's account.

Another example is a one-time payment to a person or business by a survey company for participating in a survey. After participating in the survey, the survey company provides a code and web address to the participant. The participant then accesses the web address, provides the code and the payment provider directs payment to the participant.

Another example is a one-time refund payment for a cancelled subscription where a credit exists.

Another example is for incentive programs where a cash payment is an incentive option, such as for sales incentive programs to motivate sales people to increase sales or a safety program to motivate employees to meet a safety goal or objectives. In exchange for meeting the goals, cash payments are issued. Companies desire to deliver an isolated payment to the individuals participating in the incentive program. In these cases, the employee is notified that he/she has earned a cash payment and is provided a unique code. The employee is informed to go to a web site to initiate their payment and to enter their code, and payment is then made.

Another example is the issuance of payroll checks. Companies are finding more and more that banks are not honoring payroll checks due to fraud or other reasons. Companies are looking for alternative means to provide the payment to their employees. In these instances, employees are issued their standard pay “stub” which has a unique code on the stub. The employee is directed to a web site to initiate the payment. The employee may choose various payment forms, including choosing a check to be mailed or electronic credit. In some cases, employees may not have a bank account and an electronic transfer of funds is not an option. On the web site, the employee may choose to have a check mailed to them, and they may also elect to have a check mailed to them that is drawn on a bank where they can cash the check more easily.

Another example is for sales commission payments within a sales organization, an independent sales organization, reselling network, or the like.

There are many other examples of refunds and other payments to be given to persons in exchange for services, return of goods, or other credit.

According to another aspect of the invention, the payment provider, for any of the above-described applications (rebates, refunds, single or recurring payments) of this system and method, credits a consumer's credit card account for the designated amount, rather than directing the deposit into their bank account.

According to another aspect of the invention, the payment provider, for any of the above-described applications (rebates, refunds, single or recurring payments) of this system and method, credits a consumer's account with the merchant for the designated amount, rather than directing the deposit into their bank account. According to another aspect of the invention, the payment provider, for any of the above-described applications (rebates, refunds, single or recurring payments) of this system and method, mails a check for the designated amount, rather than directing the deposit into their bank account, in response to a request, including a code or transaction identifier.

According to another aspect of the invention, the payment provider, for any of the above-described applications (rebates, refunds, single or recurring payments) of this system provides instructions to the intended recipient of the payment that he/she may utilize the telephone to initiate the payment request. Subsequently, the payment provider utilizes the system to process the payment, including the security measures, payment options, and such.

### BRIEF DESCRIPTION OF THE DRAWINGS

An exemplary version of a system and method for distributing rebates, refunds and the like is shown in the figures wherein like reference numerals refer to equivalent structure or steps throughout, and wherein:

FIG. 1 is a schematic illustration of the prior art method for dispensing a rebate;

FIG. 2 is a flow chart illustrating a method of distributing a payment according to the system and method of the present invention;

FIG. 2a is a schematic illustration of the system and method for dispensing a rebate according to the present invention;

FIG. 3 is a flow chart illustrating steps for a consumer to redeem a rebate according to the system and method of FIG. 2;

FIG. 4 is a flow chart illustrating steps for a rebate provider to issue rebates according to the system and method of FIG. 2;

FIGS. 5-16 are examples of web pages used in conjunction with performance of the system and method of FIG. 2; and

FIG. 17 is a flow chart illustrating steps in a security feature in the system and method of the present invention.

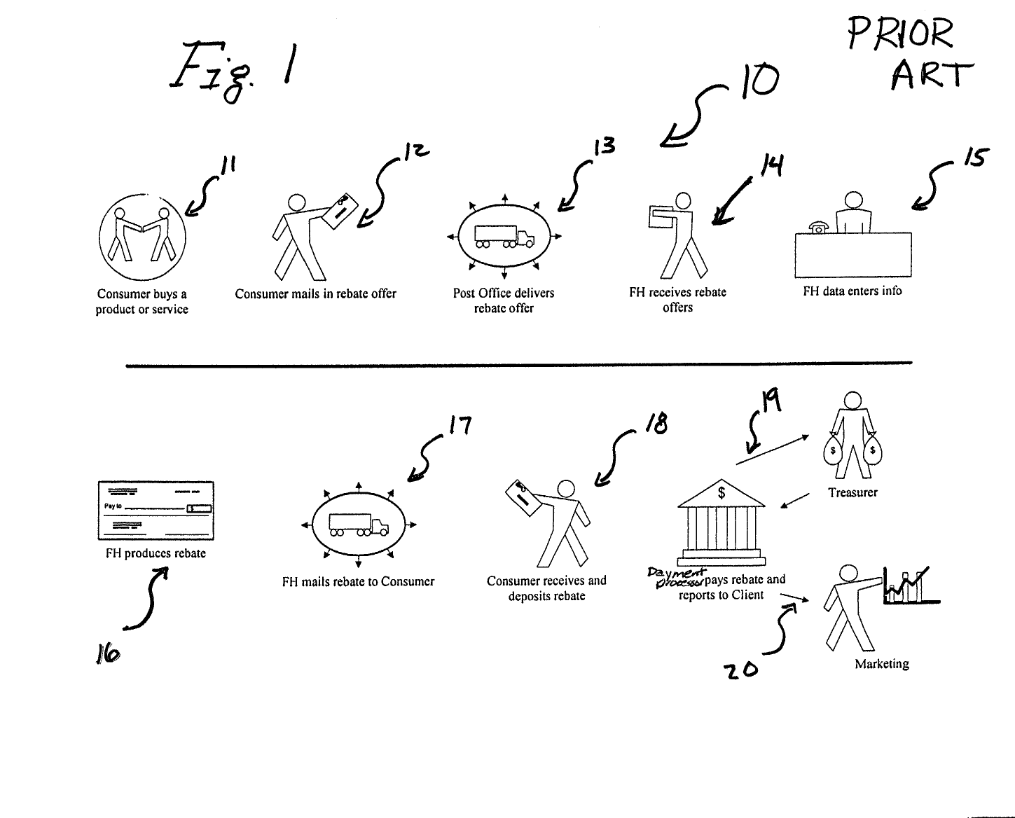

### DETAILED DESCRIPTION OF PREFERRED EMBODIMENT(S)

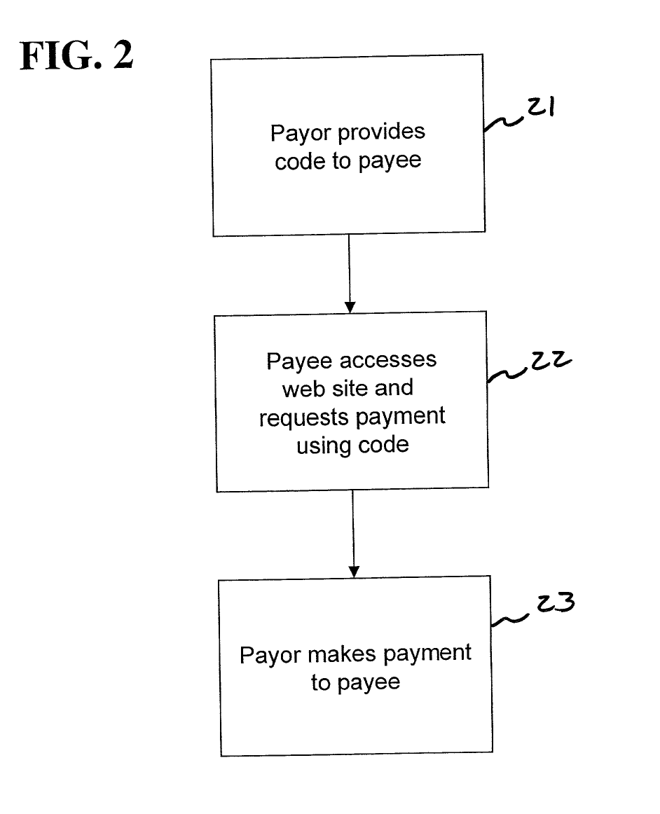

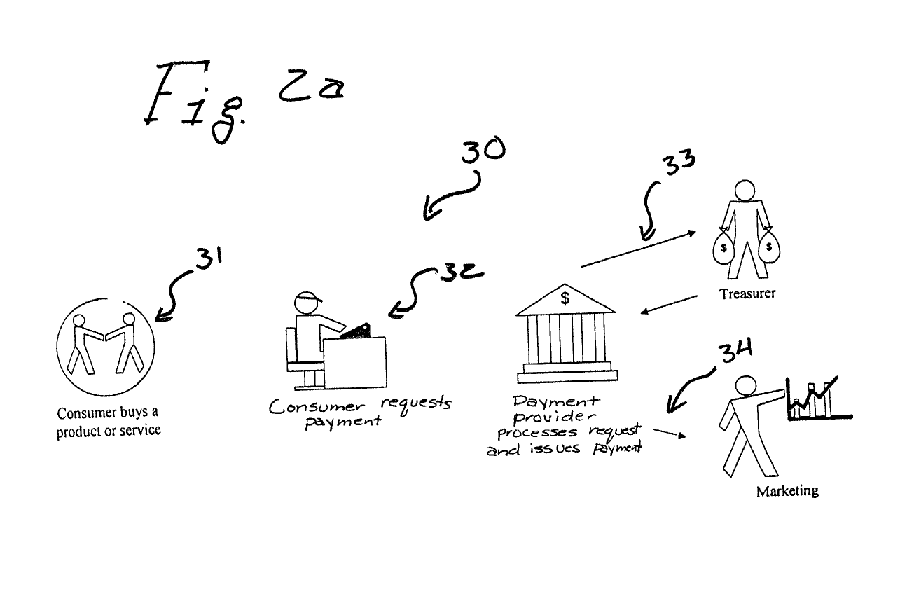

As illustrated in FIG. 2, the preferred embodiment of a payment system and method provides that a code be provided to a payee (21). The payee requests payment from the payor and the request includes the previously-assigned code (22). The payor then distributes a payment to the payee (23). In preferred embodiments, the payee makes their request for payment electronically or digitally via an input device to a computer connected to the input device for data transmission therebetween, such as via the Internet. Further, in preferred embodiments, payment is automatically made into an account specified by the payee, using an electronic data link to a computer controlling or having access to an account, such as a bank account, associated with the payee. It is anticipated that in some applications, additional parties will perform steps or portions of steps in the method described. For example, in typical practice, it is contemplated that the preferred system and method will be facilitated by a third party payment provider, though in alternate embodiments, the payment provider functions may be performed by the payor. The identity of, or nomenclature used for, the payor and payee vary from application to application. For the example applications described herein, the following terminology will be used:

| Example Application | Payor | Payee |
|---|---|---|
| Rebate | Client or Manufacturer or | Consumer |
| | Retailer | |
| Survey | Survey company or | Participant |
| | Surveyor | |
| Independent contractor | Employer | Independent |
| | | Contractor |

This system and method will be described in the context of particular exemplary applications. A preferred embodiment of the system and method of the present invention is first described in the context of a rebate redemption process.

As illustrated in FIG. 2, the preferred system and method of issuing rebates (30) is initiated when a consumer buys a product for which a rebate is offered (31). The rebate may be offered by the manufacturer or by a retailer or other entity, though typically it is the manufacturer. The product comes with directions for obtaining the rebate, including a web address for the consumer to access or a telephone number to call. In addition, the directions include a rebate identifier, such as an alpha-numeric code. Via forms on the web site, the consumer enters the requested information, including the rebate identifier (32). A payment processing entity then pays the consumer (33) and reports the payment to the manufacturer who is their client (34). The payment processing entity in typical practice is an entity separate from the manufacturer, though this is not necessarily the case.

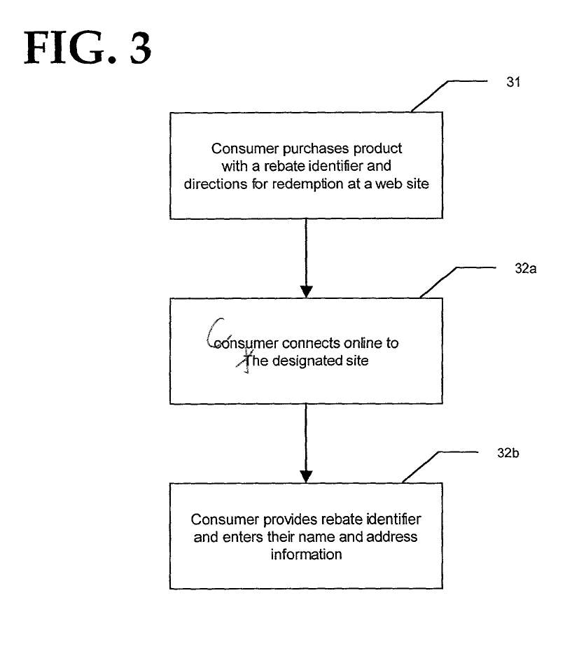

This process, as practiced by the consumer and using the internet, is illustrated by the flow chart of FIG. 3. The consumer purchases the product (31) which includes a rebate identifier and directions for redemption of the rebate via a web site. The consumer connects via the world wide web to the designated site (32a). The consumer provides the rebate identifier and enters other requested information such as the consumer's name and address (32b).

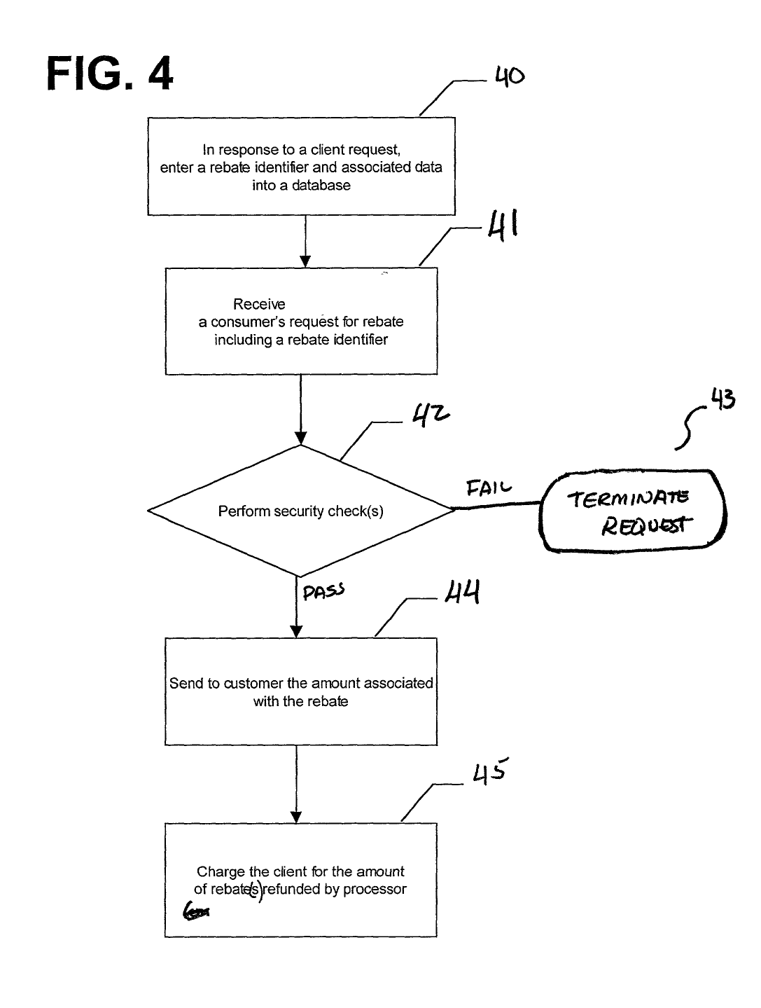

The process performed by the payment processor, in cooperation with the consumer's actions, is illustrated by the flow chart of FIG. 4. As used herein, “client” shall mean a manufacturer or any other entity that is offering a payment. In response to a client request, the payment processor stores an eligible rebate record in a database (40). A rebate record contains an associated identifier and the eligible dollar amount. Rebate identifiers may be assigned by the client or payment processor. If assigned by the client, the client transfers to the payment processor a file containing rebate identifiers stored in association with the rebate amount, the name of the manufacturer and other pertinent data.

The payment processor hosts a web site that provides forms for consumers to enter their rebate information. Alternatively, the web site might be hosted by another entity, such as the manufacturer, but connected for data transmission from the web site to the payment processor. When a consumer accesses that web site to request a rebate, the payment processor receives, the request, including the rebate identifier and the consumer's name and address information (41). The information is automatically entered into the payment processor's database, in a transaction record, which includes a unique transaction identifier, the rebate identifier, the consumer name and address, and other collected data. The payment processor performs a validation process against the original data supplied by the client (42) to confirm that the rebate is legitimate. If the rebate identifier does not match a rebate identifier stored in the processor's database, an error message is displayed to the consumer (43). If the rebate identifier does match, the rebate request is accepted, pending any other security checks. If the results of subsequent security checks are acceptable, then the payment is scheduled for issuance to the consumer. Additional security measures can be incorporated, and are discussed below. Security checks and validation of the rebate request is typically done real-time so that the consumer is immediately notified of the acceptance of the request. However, these validation and security measures can be done off-line with the consumer notified later that their payment has been accepted/denied.

Upon issuance, the payment processor either makes the payment to the consumer (44) and is redeemed by the client (45). Alternatively, in step 44, the payment processor directly issues payment using client funds (not shown). These payments may be made as individual transactions or as batch payments.

The preferred system and method facilitate a number of features that add to the system's advantages. For example, a status feature allows a user to check on the status of a rebate previously requested. This is accomplished by providing the user with a unique rebate identifier during or at the end of their request session, preferably after the rebate has cleared security checks. This unique number is assigned and stored in the database where the rebate identifier is stored in association with a status field. A status check web page or feature on a web page allow the user to enter their unique rebate identifier and the payment processor's system looks up the rebate status.

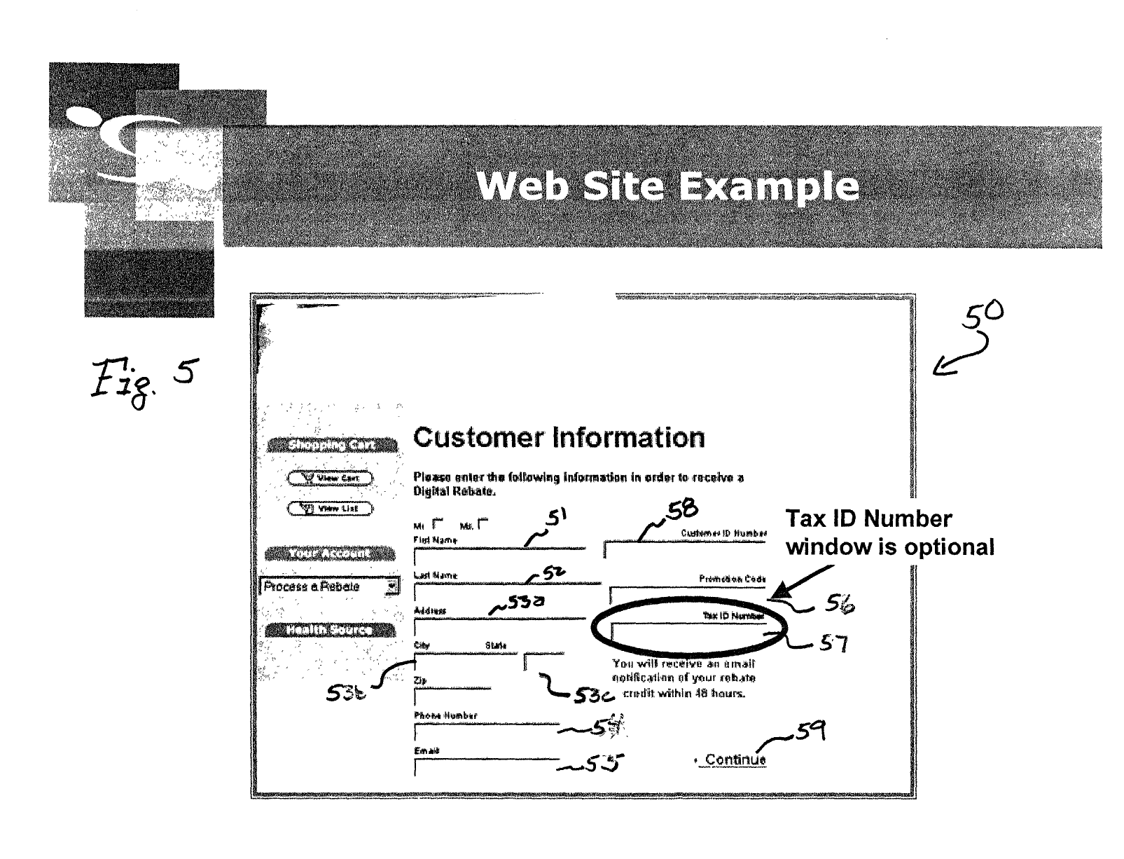

FIGS. 5-14 illustrate example web pages for processing a rebate according to the present invention. It should be understood that aspects of these web pages are cosmetic and can be altered within the spirit of this invention. Further, the description below follows a particular path through the web pages, but it will be understood that other flow paths might be chosen by the user and the site host might organize its pages in a different flow path but still follow the system and method of the present invention. The web pages include forms for eliciting and transmitting data between the consumer and the payment processor. In some cases, these forms are accessed by the consumer via a web site associated with or hosted by the manufacturer of the product. The manufacturer periodically uploads, or the payment provider downloads, a batch of records collected via the forms, and the records are automatically entered into the payment processor's database. The records can also be uploaded or downloaded on a real-time basis rather than a batch process. This provides rapid or immediate response to the consumer on whether the payment request has been approved or denied.

Alternatively, these forms may be accessed via a web site hosted by the payment processor and the data entered by the consumer is automatically transferred into records in the payment processor's database. FIG. 5 shows a first web page form 50 having fields for collecting the consumer's first 51 and last names 52, address 53a, city 53b, state 53c, zip code 53d, phone number 54, email address 55, “promotion code” or rebate identifier 56, and a tax ID number 57. In addition, the page 50 includes a field for a “customer ID number” 58. Such a field would be useful in an application where the client and the consumer have already established a relationship and the client has supplied the consumer with an identifier or where the transaction will result in a payment of income that must be reported to the Internal Revenue Service. The fields identified in FIG. 5 are variable and are merchant specific, and the amount of the data collected and/or required is determined by the merchant and/or the rebate program.

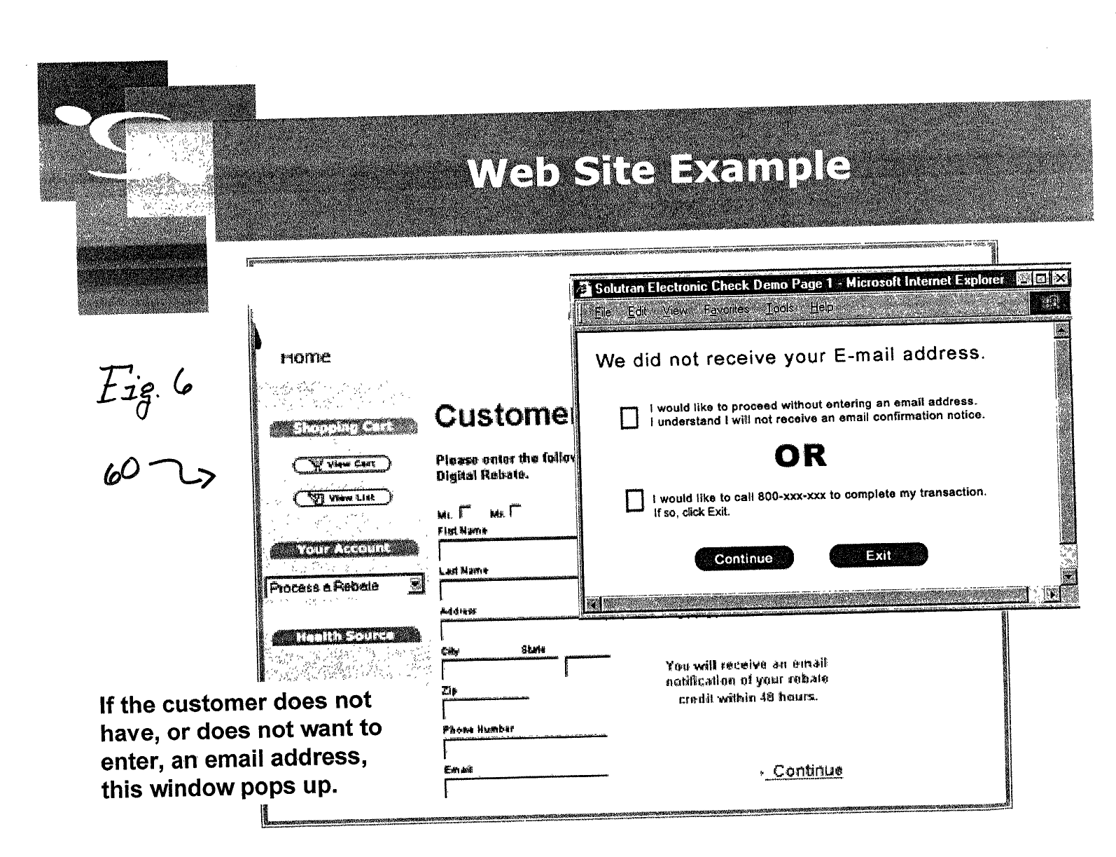

In the example illustrated, when the consumer has entered the specified information, he or she will click on the “continue” link 59. If a consumer fails to enter data in a required field, the system does not continue without an entry, as shown in FIG. 6 if the consumer had omitted their email address in field 55.

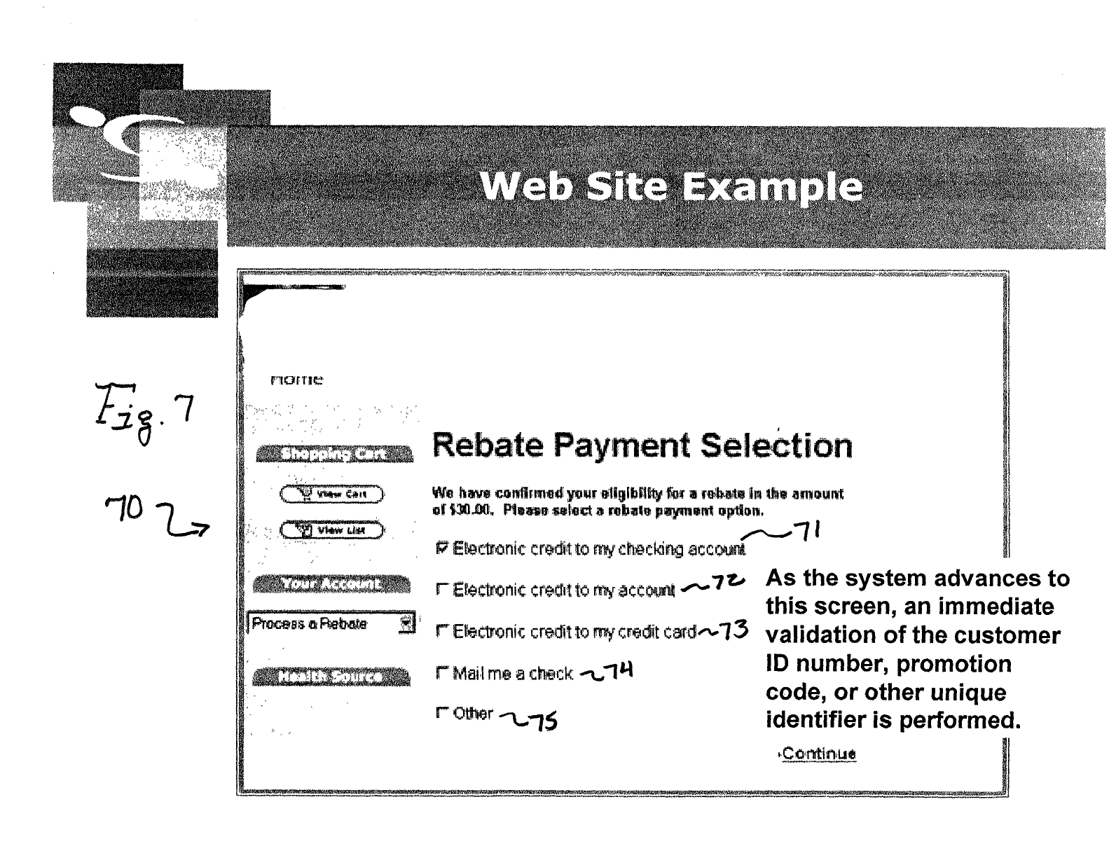

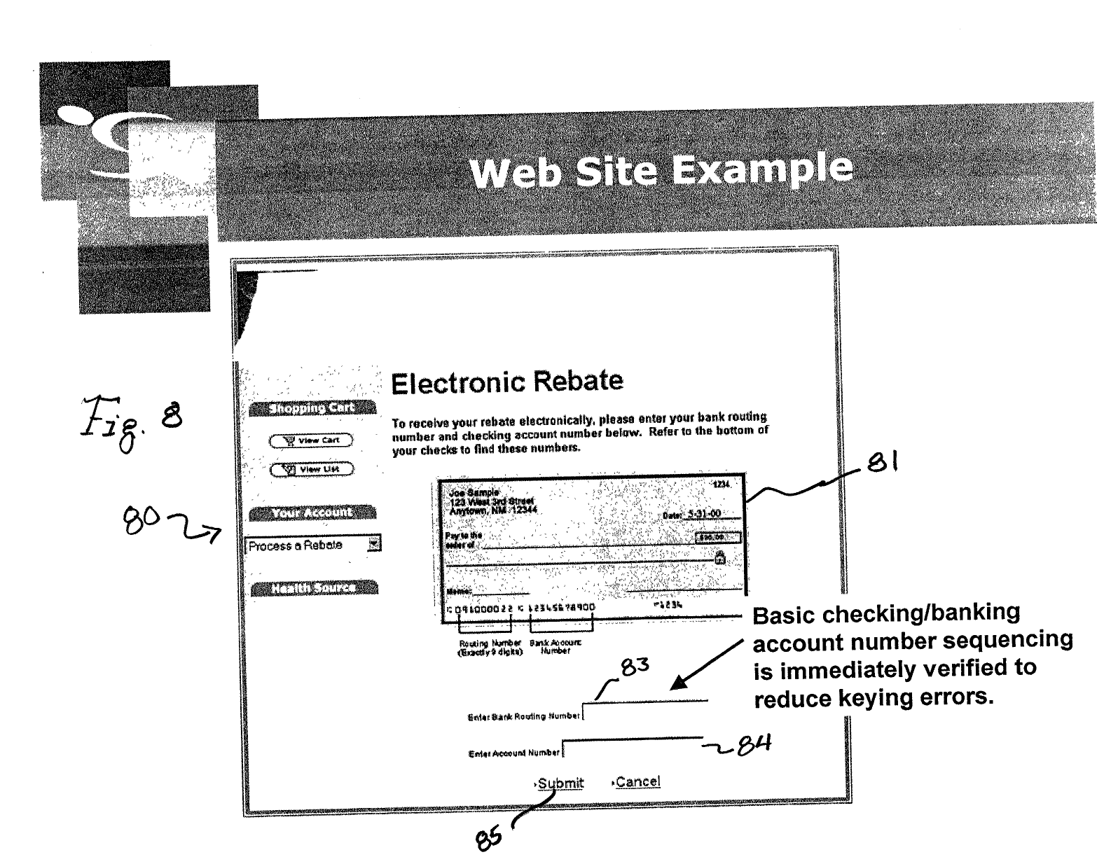

If the consumer had entered their email address at screen 50, the screen or page 70 illustrated in FIG. 7 would appear. As the system advances to this screen 70, an immediate validation is done via the payment processor's database of the rebate identifier or other unique identifier provided in screen 50. In screen 70, the consumer is offered several options for receiving payment. The first option is an automatic credit to a bank account 71. If the consumer selects this option 71, the system advances to the screen 80 illustrated in FIG. 8. Screen 80 illustrates a check 81 to help the user identify where to find the requested information. Screen 80 elicits the consumer's bank routing number 83 and their account number 84. The payment processor immediately performs basic checking/banking account number sequencing to determine whether the consumer has made errors in the entering of this information.

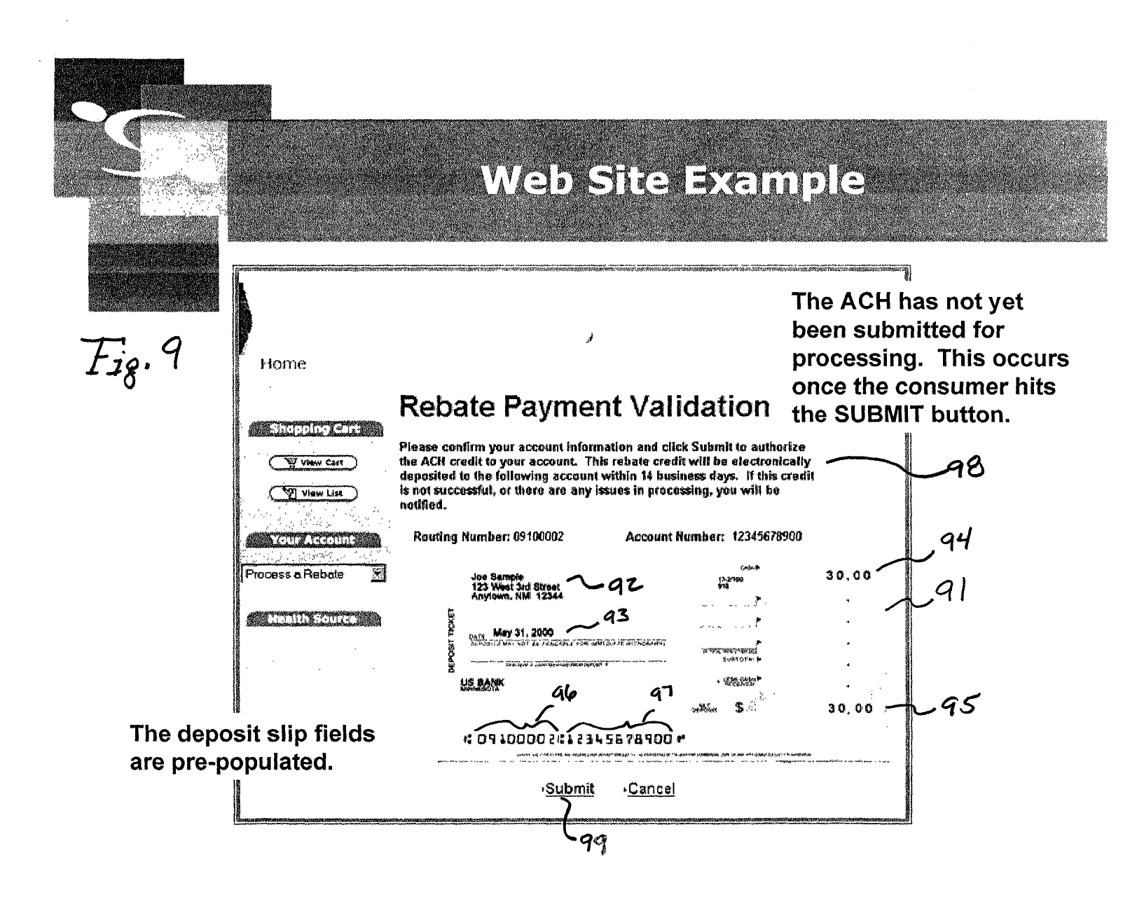

Upon clicking the “Submit” link 85 on screen 80, the system advance to screen 90, illustrated in FIG. 9. This screen illustrates a mock deposit slip 91 with its data areas populated. For example, the deposit slip includes the consumer's name and address 92, the date of deposit 93, the deposit amount 94 for this transaction and a total deposit amount 95. The mock deposit slip 91 further includes the routing number 96 and account number 97. A text message 98 asks the user to confirm all illustrated information.

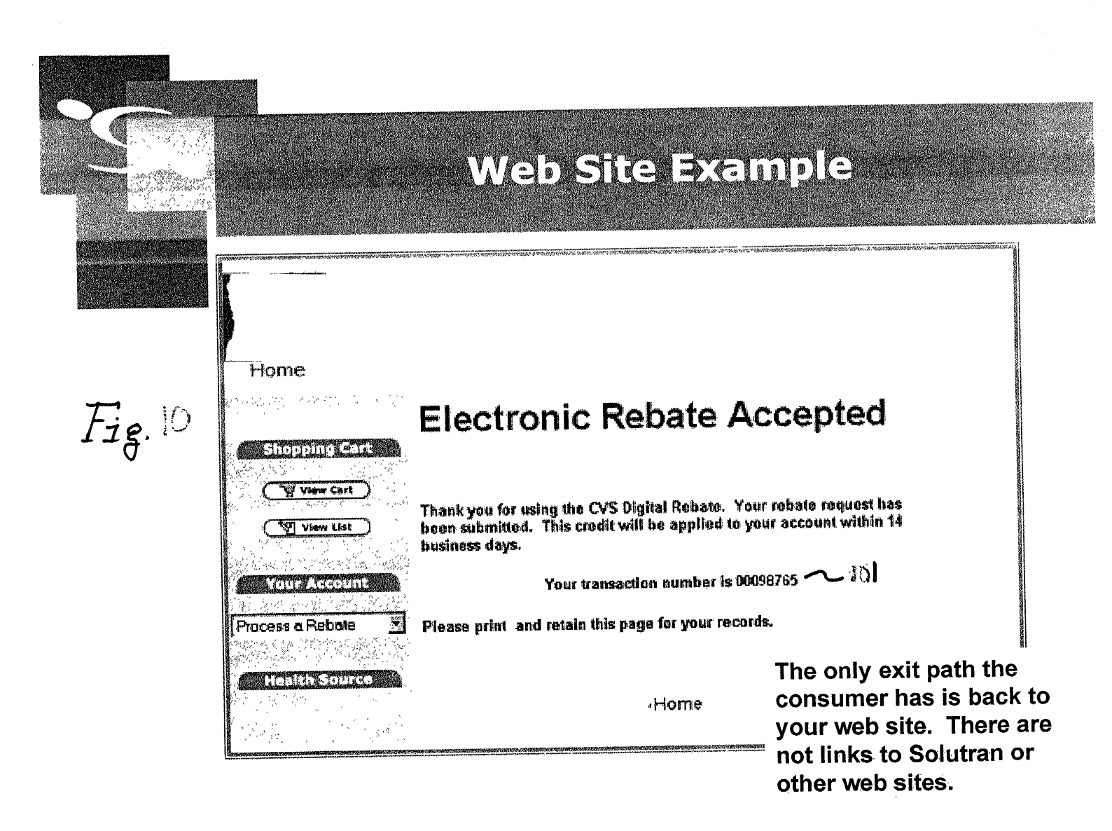

Upon clicking “Submit” link 99 on screen 90, the system advances to screen 100 illustrated in FIG. 10. This text screen advises the consumer that they have completed the rebate registration process and identifies a unique transaction number 101 which can be useful in tracking the transaction if, for example, a user wants to check the status of a rebate or if there is some problem with redemption and the transaction must be found and investigated.

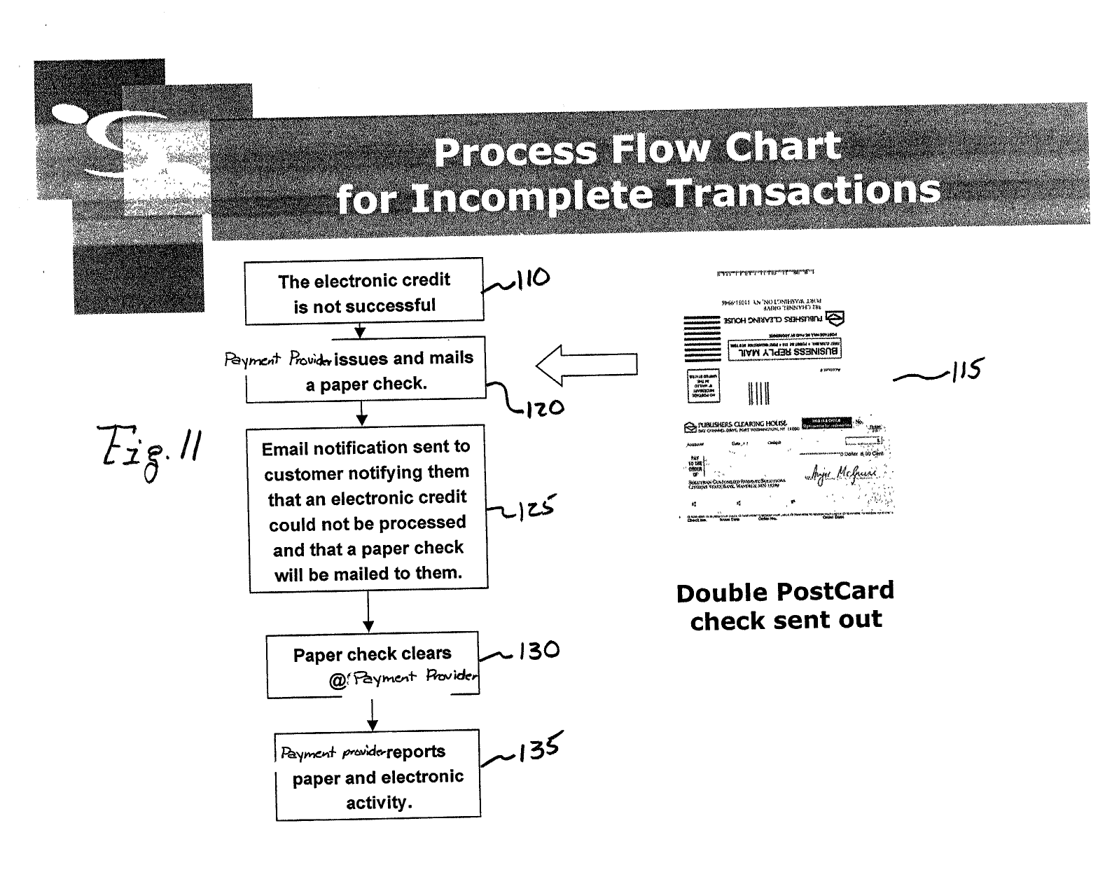

FIG. 11 illustrates a flow chart of what happens if an electronic credit to the consumer's bank account cannot be processed by the payment processor (110). The payment processor mails a paper check 115 to the consumer (120). The system sends an email message (if an email address was provided) to the consumer notifying him/her that an electronic credit could not be processed and that a paper check will be mailed (125). When the consumer cashes the paper check, the check clears or is paid on the payment processor's account (130). The payment processor reports its rebate activities to the client/manufacturer (135).

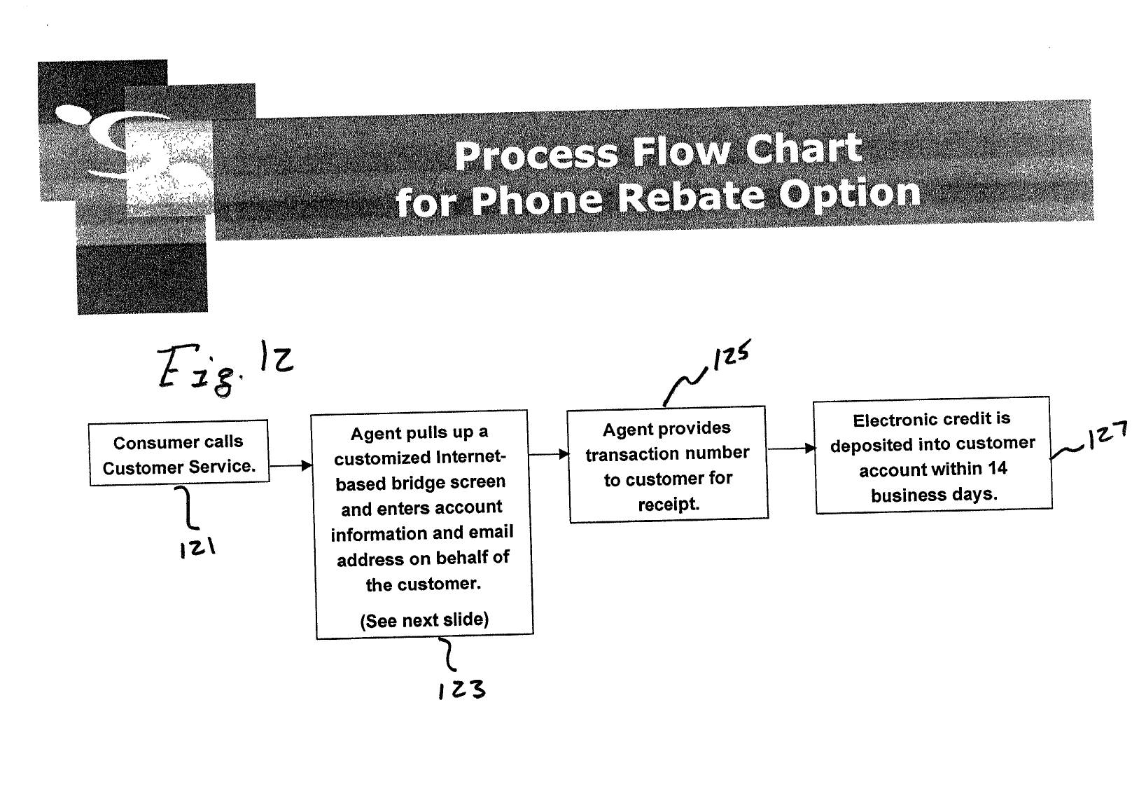

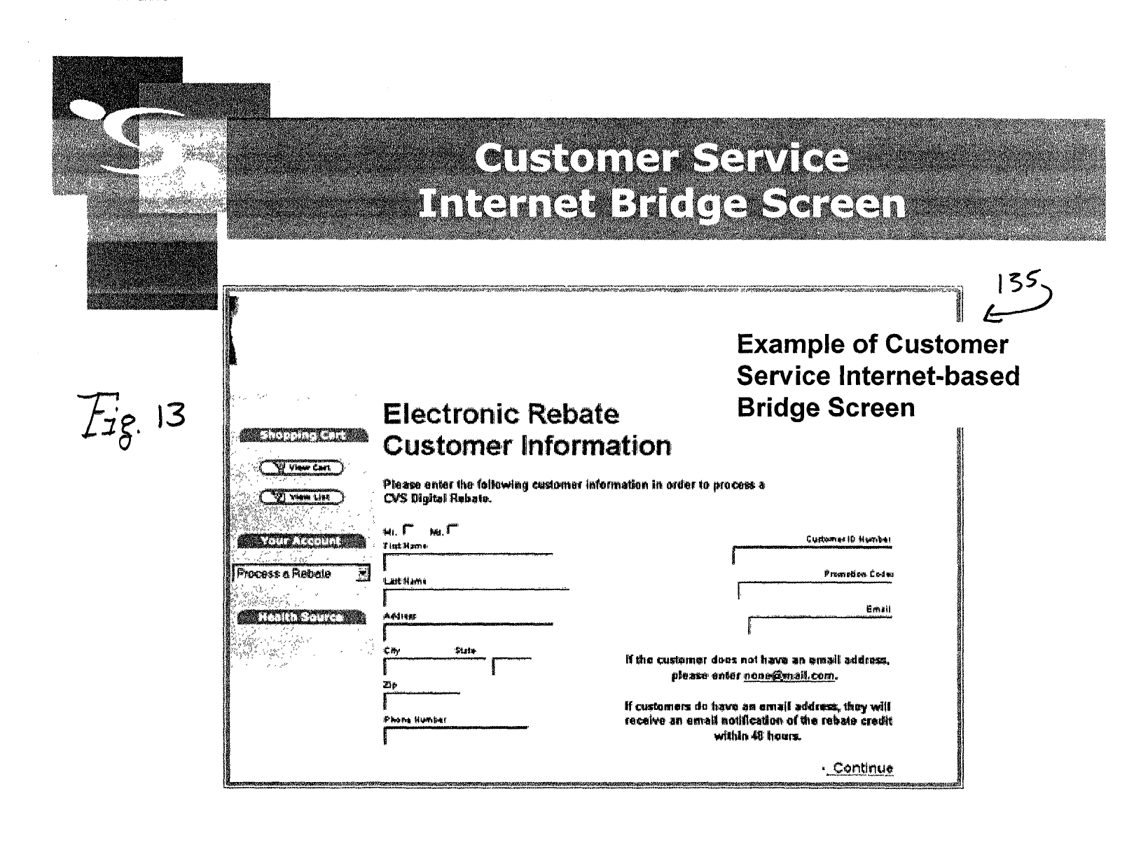

As an alternative to online rebate registration, the system provides for a consumer to register for a rebate via a telephone call. As illustrated by the flow chart in FIG. 12, this process is initiated when a consumer call a designated phone number, such as a customer service representative for the payment processor (121). The customer service representative accesses, via a computer, a customized screen 135 and enters account information on behalf of the customer (123). The customized screen 135 is depicted in FIG. 13. It includes fields for the consumers first and last names, address, phone number, “promotion code” or rebate identifier, email address, and customer identifier. To facilitate automatic credit to a bank account, the consumer is also asked to provide a routing number and bank account number. With this information entered, the customer service representative provides a transaction number to consumer for receipt (125). The payment provider orders an electronic deposit into the consumer's account (127).

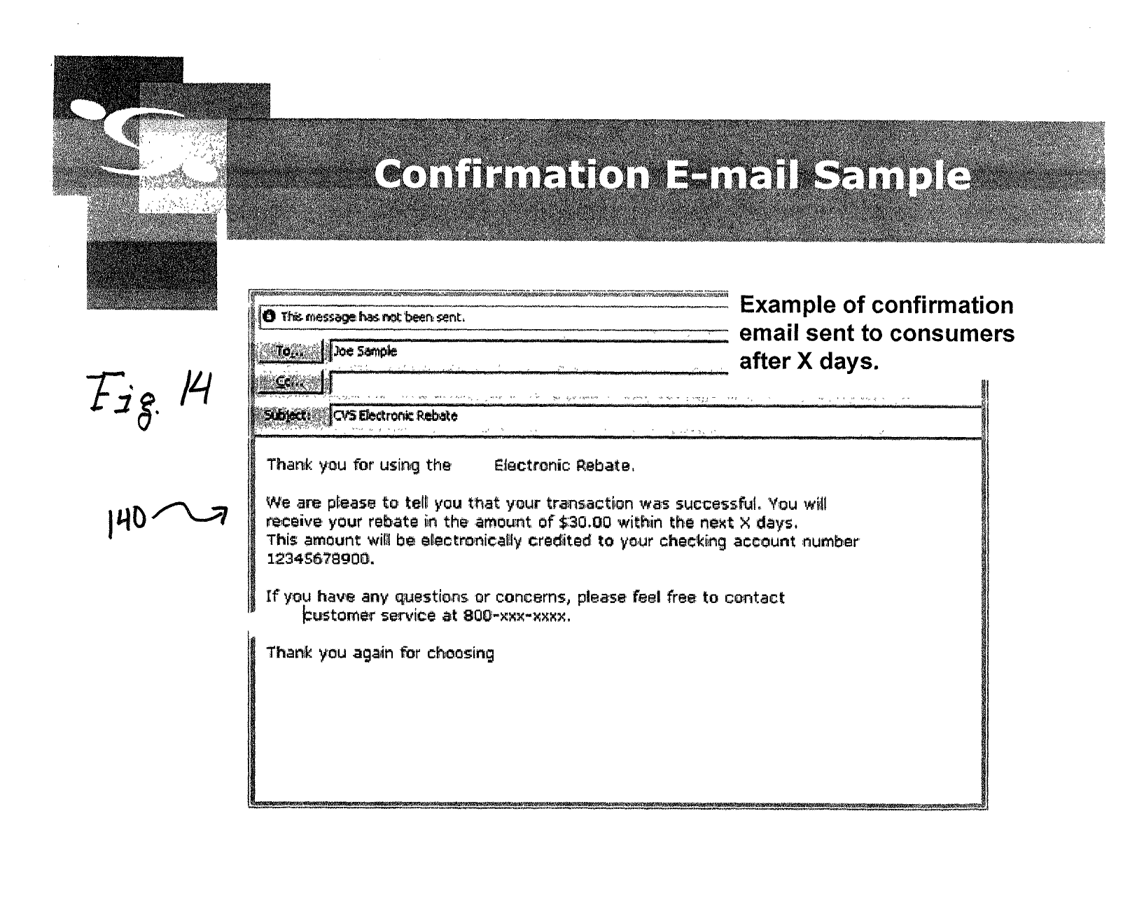

FIG. 14 illustrates an email message 140 that is sent to the consumer to confirm that the transaction has been processed and that payment will be made to the consumer's account within a specified period of time.

The system and method described allow for variation within the spirit of the invention. For example, at screen 70 in FIG. 7, the consumer might select “electronic credit to my account” 72, in an application in which the consumer has an account with the manufacturer or other entity offering the rebate. With such a selection, the system would electronically or digitally send the information necessary to the manufacturer's accounting system to update the consumer's account to reflect the credit.

As another alternative, in response to screen 70, the consumer might select “electronic credit to my credit card” 73. In the U.S., credit card companies generally do not allow a credit to a card account unless there is an associated debit. To accomplish this, the system could direct a charge to the consumer's account for some minimal amount, say one cent, and then direct a credit in the amount of the rebate plus the minimal charge.

As another alternative, in response to screen 70, the consumer might select “mail me a check” 74. The payment processor would then produce a paper check and mail it to the consumer at the address given in screen 50.

The system further contemplates “other” 75 alternative choices for the consumer.

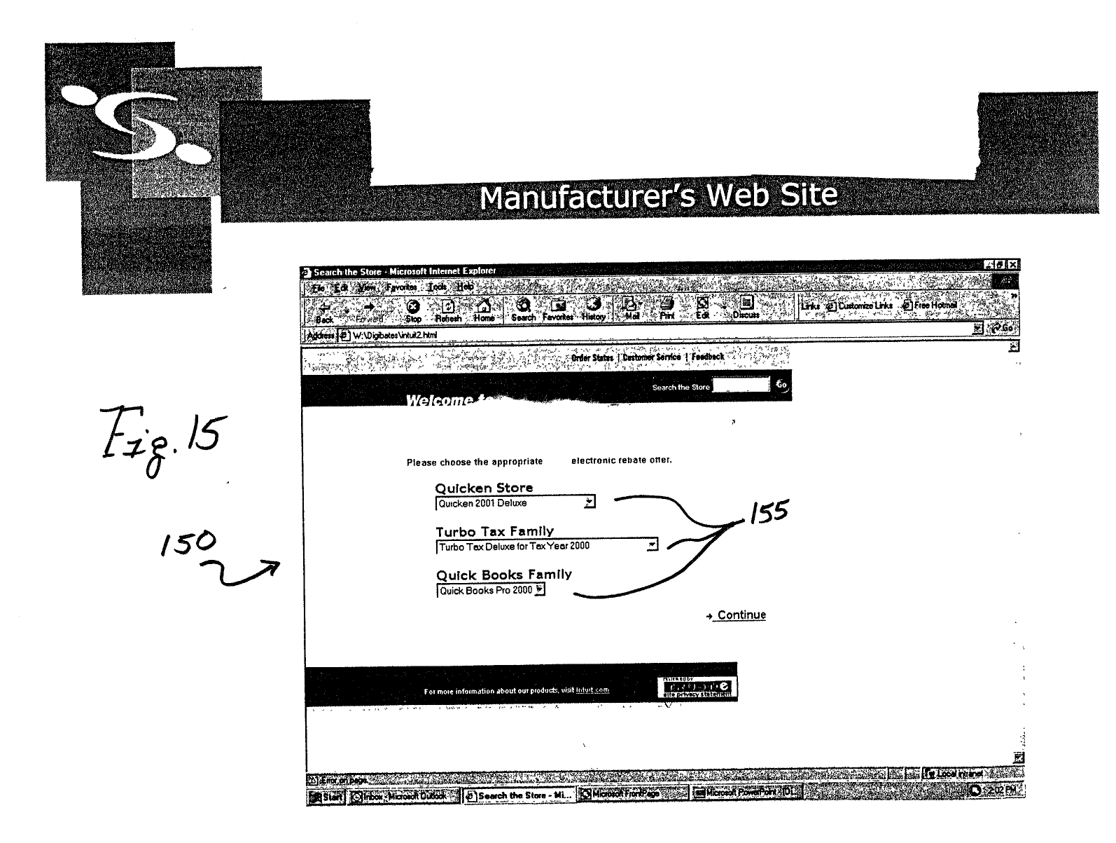

FIG. 15 illustrates an example of an alternative page 150 in the flow of web pages through which a consumer progresses during rebate registration. Screen 150 would be used in an application wherein a manufacturer, or other entity offering a rebate, is simultaneously offering multiple rebates. The consumer selects from the predefined lists 155 which rebate offer they are seeking to redeem.

Although this example defines a rebate process, a similar process is used for refunds and other payments. When a consumer is owed a refund, a refunder provides to the consumer a unique code. The refunder provides to a payment processor a list of the unique code or codes that they have issued, with each code being associated with an amount. Preferably via forms on a web site, the consumer requests a refund from the payment processor. The consumer's request includes their unique transaction code. Optionally, the request also includes information to identify an account into which the consumer would like the refund deposited. The payment processor interrogates its database to determine whether the code is valid and to confirm that the transaction has not already been completed, i.e. that the refund has not already been paid. If the refund is valid and has not yet been paid, the payment processor issues payment, preferably by digitally or electronically ordering a deposit into the consumer's account.

Security Measures

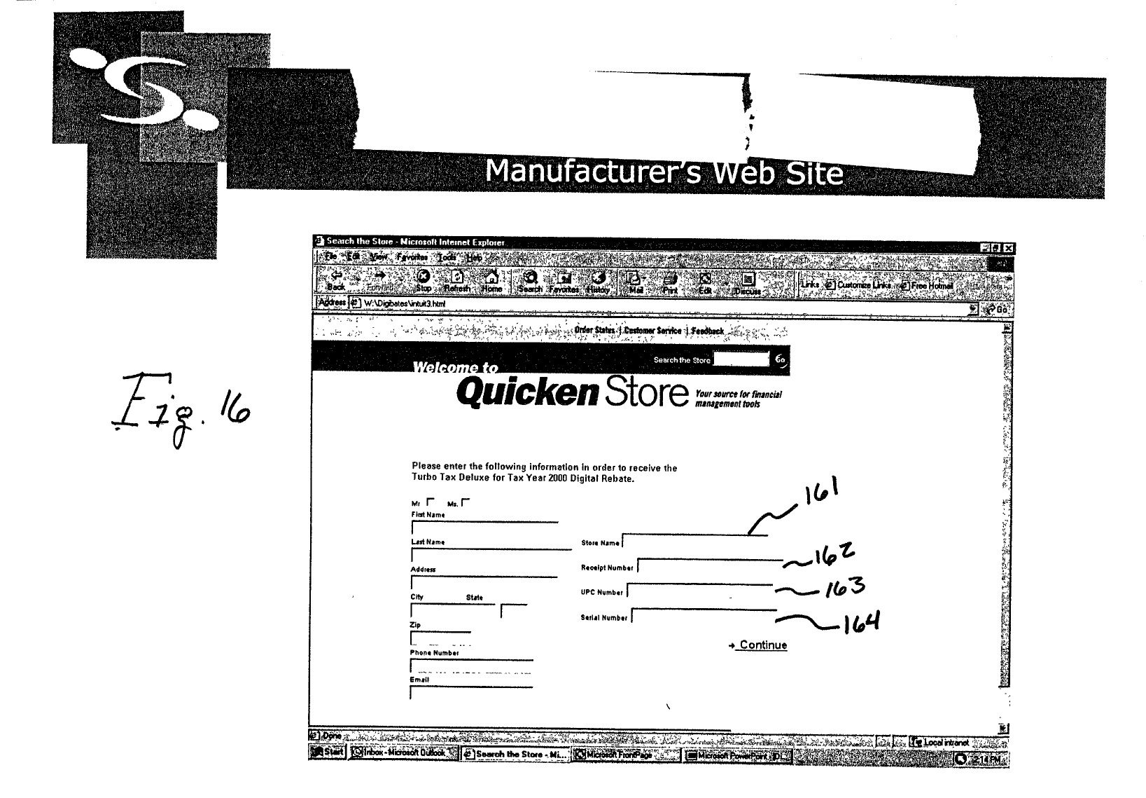

As noted above, this system and method offers optional security measures. One such measure, the “positive pay control”, is implemented with a web page 160 like that illustrated in FIG. 16. When a consumer seeks to redeem their rebate, page 160 requires that they enter various items that the payment processor can use to verify that the payment is due. The items requested or used for the security check will vary from application to application, depending on the degree of security desired by the manufacturer or payor. In some cases, each individual product has its own unique serial number and this can be used in conjunction with the security checks. In other cases, individual products do not have serial numbers.

FIG. 16 illustrates an example in which the following items are requested for the security check in a rebate application: the name of the store in which the consumer purchased the product 161, the receipt number 162 on the receipt listing the subject product, the UPC code 163 from the product packaging, and a the product's serial number” 164 which is unique to the individual product. In a preferred embodiment, the receipt number is assigned by the store from which the consumer purchased the product. These receipt numbers are transmitted from the store to the payment processor and stored in the payment processor's database in association with the rebate identifier. Upon receiving the data from screen 160, the payment processor interrogates its database to determine whether the receipt number is stored in association with the rebate identifier. If so, the rebate process proceeds. If not, an error message is provided. This “positive pay” feature of the system ensures that no duplicate printed or electronic check, is issued, paid or even initiated for any given record. Additionally, the system will not allow duplicate entries under the same unique promotional number, or rebate identifier, assigned to each record.

Yet another security measure facilitated by this system and method is “velocity monitoring”. The system conducts immediate velocity checking of the record to identify duplicate entries. Three components are optionally monitored:

1. The magnetic ink character recognition (“MICR”) (bank and account number) line entered by user, preferably in conjunction with the date of requests for a rebate.

2. The name and address fields. Various combinations of first, last, address, and ZIP can be established.

3. The E-mail address provided.

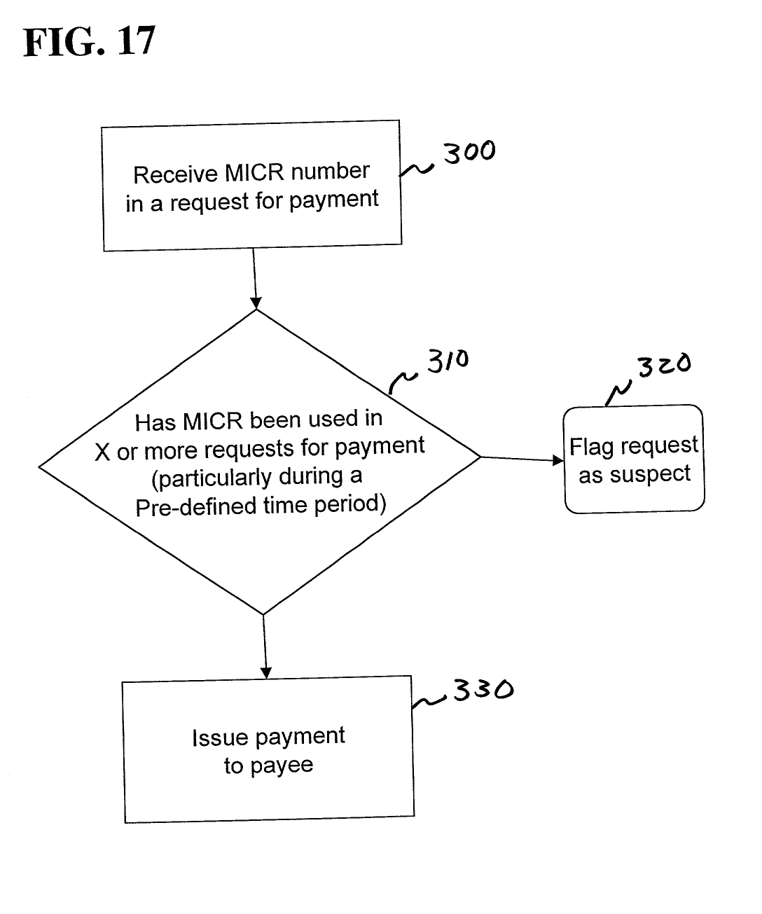

To facilitate a MICR monitor, the payment processor establishes a database containing records pertaining to transactions of more than one, and preferably many, manufacturers or payors. As illustrated in FIG. 17, when a payment request from a consumer/payee is received including the consumer's MICR number (300), the MICR number is compared to records of not only the manufacturer/payor of the rebate or payment immediately involved, but also the records of other manufacturers or payors. The system counts the number of times the MICR has been used, preferably during a pre-defined period of time (310). If the MICR number has been used in conjunction with a suspect number of other transactions (320), particularly over a given period of time, the transaction is flagged as suspect and put on hold or rejected according to the manufacturer's prescription. Otherwise, the payment is issued (330).

At the set-up of the client's account with a payment processor, the payment processor will set the control level the client will have for each fraud-monitoring element, in accord with the client's desires. For instance, the client may elect to have the payment processor flag each duplicate household address; alternatively, the client may elect to have the payment processor flag each duplicate household address once a certain number is identified. For each record that is flagged as suspect, the scheduled payment will be put ‘on-hold’ or is rejected until the client informs the payment processor of disposition.

The system and method provide yet another opportunity for securing the rebates against fraud: “auto-programming protection”. To prevent internet hackers from instituting an automatic fraud program to obtain payments, a preferred rebate redemption system has a built-in system to require a person to be present at each session. A visual response and entry is required to conduct the payment request, thereby eliminating the possibility that a hacker can build a program to automatically enter sequential codes.

Another security feature prevents someone from monitoring the website and session to “steal” the confirmation code in the middle of a session. To accomplish this, the rebate redemption system has a dual validation system at the beginning and end of each session and these two elements must correlate for a transaction to be successful.

Another optional security measure involves the use of the NEPPS (National Electronic Payment Protection System). The system compares each record against the NEPPS database, which includes records from other national firms issuing electronic and paper rebates or refunds. The system will identify and deliver to the client's account any “hits” against this database which may indicate potential fraud activity against the client's account.

Another optional security measure is the use of the Rebate Data Center which catalogues and names and addresses of persons known to have committed or attempted to commit rebate fraud. A name and address of a person requesting a rebate would be checked against the Rebate Data Center database to identify potential fraud activity.

As an option, each record can be compared against a negative database of “bad check” writers, such as SCAN (Shared Check Authorization Network) to add one more level of fraud protection.

Other protection elements can be incorporated into this rebate redemption system, such as:

Encryption Protection, such as 128 SSL bit encryption;

Verisign® Payment Security

The preferred system and method eliminates the possibility of altered check fraud. The system will not allow a payment to be made that does not match the amount approved by the client.

The system and method of the present invention, when implemented with automatic deposit into a consumer's account, requires the identification of a consumer's bank account in order for electronic payments to be made. This inherently is an effective fraud deterrent, especially for medium to small payments, for to fraud the system, new bank accounts would need to be opened and closed repeatedly.

Applications, other than Rebates, for the System and Method of the Present Invention

The system and method of the present invention have been described above in conjunction with the redemption of rebates and refunds. However, this technology is foreseen to have a number of other applications. Here follows a list of examples that should not be interpreted as exhaustive:

Single payment to an independent contractor by an employer for services performed. After performing services, the employer provides the contractor with a code and web address. The contractor accesses the web address, provides the code and, optionally, their bank account number and routing number. The payment provider transmits payment directly to the contractor's account.

One-time payment to a consumer by an internet survey company for the consumer's participation in a survey. After participating in the survey, the survey company provides a code and web address to the participant. The participant then accesses the web address, provides the code and the payment provider directs payment to the participant.

A one-time refund payment for a cancelled subscription where a credit exists.

Payments in conjunction with an incentive programs where a cash payment is an incentive option, such as for sales incentive programs to motivate sales people to increase sales or a safety program to motivate employees to meet a safety goal or objectives. In exchange for meeting the goals, cash payments are issued. Companies desire to deliver an isolated payment to the individuals participating in the incentive program. In these cases, the employee is notified that he/she has earned a cash payment and is provided a unique code. The employee is informed to go to a web site to initiate their payment and to enter their code, and payment is then made.

Issuance of payroll checks. Companies are finding more and more that banks are not honoring payroll checks due to fraud or other reasons. Companies are looking for alternative means to provide the payment to their employees. In these instances, employees are issued their standard pay “stub” which has a unique code on the stub. The employee is directed to a web site to initiate the payment. The employee may choose various payment forms, including choosing a check to be mailed or electronic credit. In some cases, employees may not have a bank account and an electronic transfer of funds is not an option. On the web site, the employee may choose to have a check mailed to them, and they may also elect to have a check mailed to them that is drawn on a bank where they can cash the check more easily.

Sales commission payments within a sales organization, an independent sales organization, reselling network, or the like.

This system and method provide innumerable advantages and opportunities. For example:

On-line money credits can be given without requiring a membership or formal registration. For the same reasons, this system is particularly adept at facilitating one-time transactions;

The system accommodates both phone and internet redemption;

The system is flexible enough to incorporate the issuance of a paper check when an electronic credit is not elected or desired;

The web forms are easily customizable to collect the data that the client/manufacturer would like. For example, the forms can collect the consumer's tax identification number;

By automatically storing the data entered by the consumer, transcription errors are eliminated;

The system and method provide for the crediting of credit cards

Because the paper check clearing element is combined with the electronic payment element, the system can provide fully integrated reporting of all payment options and types;

This system is easily implemented anywhere on the globe, with any of the actors (the client/manufacturer, the consumer, and the payment processor) being located anywhere; the payment processor does not depend upon the delivery of mail which can be particularly unreliable in some locales;

The automation of the system keeps the costs per transaction extremely low; further, the system can accommodate small payments as well as large payments, and therefore can be used to distribute very small rebates or payments (“micropayments”) or the like;

The system and method can be used in business-to-business applications as well as business-to-individual-consumer;

The system provides cost benefits to retailers, manufacturers and to consumers. In the context of a rebate application, consumers will find it easier and faster to redeem their rebate online, making it more likely that they will redeem the rebate. Manufacturers benefit from the data that is accurately and completely collected and reported to them; this helps manufacturers develop appropriate loyalty programs to better market their products. Manufacturers will receive data on the rebate program in a much faster time frame than with traditional rebate processes. Further, manufacturers will benefit from the elimination of the cost of mailing a paper check. Retailers benefit by improving customer satisfaction. In general, retailers strive for a high redemption rate on rebates and this easy-to-use system will increase redemption rates. Further, retailers often are required to coordinate the management of the rebate redemption coupon, i.e. an employee of the retailer provide a paper coupon to the consumer. This system and method can alleviate the retailer of that responsibility. Still further, it is common practice for retailers to coordinate a rebate program. However, with this system and method, the retailer is freed of that duty as well. And further still, if the retailer's web site is used as the gateway for the redemption, this sytem and method will drive traffic to the retailer's web site, providing them increased opportunity for marketing and sales.

Although an illustrative version of the device is shown, it should be clear that many modifications to the device may be made without departing from the scope of the invention. A “computer”, as used herein, means any device having data processing capabilities and either data storage or the ability to access stored data via electronic data transmission. A “database” is any stored list or table of data containing or having the ability to contain at least one record. Further “database” includes any data storage scheme that links or associates one identifiable piece of information with another. A “consumer” can be an individual or any other entity such as a business, partnership, corporation, organization, or association.

It is claimed:

1. A system for distributing a payment, comprising:
a) means for assigning a unique transaction code;
b) means for communicating said transaction code to a payee,;
c) means for payee to request payment from a payor, said request including said transaction code, said payment request means including computers networked for data transmission therebetween; and
d) means for distributing payment to the payee.

2. A system for distributing a payment according to claim 1, wherein said payment distribution means includes means for digitally depositing the payment into an account of the payee's choice.

3. A system for distributing a payment according to claim 1, wherein said means for assigning a unique transaction code includes a database that assigns a unique transaction code and stores this code in association with a payment amount.

4. A method for distributing a payment, comprising the steps of:
a) assigning a unique transaction code;
b) communicating said transaction code to a payee;
c) receiving from payee, via computers networked for data transmission therebetween, a request for payment from a payor said request including said transaction code;
d) distributing payment to the payee.

5. A method for distributing a payment according to claim 4, further comprising the step of receiving payee's choice of account and wherein said payment distribution step includes digitally depositing the payment into said account of the payee's choice.

6. A method for distributing a payment according to claim 4, further comprising the step of storing the assigned transaction code in association with a payment amount.

7. A method for distributing a rebate, comprising the steps of:
a) offering a rebate in exchange for the purchase of a product;
b) assigning to the product a product identifier;
c) selling the product to a consumer;
c) assigning a unique transaction code to the sale and providing the transaction code and the product identifier to the consumer;
d) storing the transaction code in association with the product identifier of the purchased product;
e) receiving a request from consumer to receive rebate, said request including said product identifier and said transaction code;
f) providing rebate to consumer.

8. A method according to claim 7, further comprising the step of:
g) storing a rebate amount in association with the product identifier; and wherein the step of providing the rebate includes providing the rebate for the stored amount of the rebate.

9. A method according to claim 8, further comprising the step of:
g) printing the transaction code on a sales receipt.

10. A method according to claim 9, further including the step of printing on the sales receipt the date of purchase.

11. A method according to claim 9, further comprising the step of printing on the sales receipt a textual description of the product.

12. A method according to claim 10, further including the step of printing on the sales receipt the time of purchase.

13. A method according to claim 8, further comprising the step of printing on the sales receipt the name and location of the retailer which sold the product.

14. A method of screening a rebate redemption for potential fraud, comprising the steps of:
a) maintaining a database of redeemed rebates, said rebate database including rebate records for rebates redeemed by more than one manufacturer, a rebate record including information associated with the entity that received the rebate;
b) upon receiving a rebate redemption request containing information associated with the requester, searching the database of redeemed rebates to find rebates previously redeemed to the requester.

15. A method of screening a rebate redemption request for potential fraud wherein said information associate with the entity includes a magnetic ink character recognition number for an account associated with the entity.

16. A system according to claim 1, wherein said payment distribution means includes computers networked for data transmission therebetween.

17. A system according to claim 1, wherein said payment distribution means includes the mailing of a paper check.

18. A method according to claim 4, wherein said step of distributing payment to the payee is accomplished via computers networked for data transmission therebetween.

19. A method according to claim 4, wherein said step of distributing payment to the payee is accomplished by mailing a paper check to the payee.
